(19) United States
(12) Patent Application Publication
(10) Pub. No.: US 2018/0120262 A1
(43) Pub. Date: May 3, 2018

(54) NON-CONTACT DYNAMIC STIFFNESS MEASURMENT SYSTEM AND METHOD

(71) Applicant: INDUSTRIAL TECHNOLOGY RESEARCH INSTITUTE, Hsinchu (TW)

(72) Inventors: Chung-Yu TAI, Kaohsiung City (TW); Chen-Yu KAI, Pingtung County (TW); Ta-Jen PENG, Taichung City (TW); Yi-Hsuan CHEN, Nantou County (TW)

(73) Assignee: INDUSTRIAL TECHNOLOGY RESEARCH INSTITUTE, Hsinchu (TW)

(21) Appl. No.: 15/384,228

(22) Filed: Dec. 19, 2016

(30) Foreign Application Priority Data
Oct. 28, 2016 (TW) 105135179

(51) Int. Cl. G01N 29/04; G01N 29/24

(52) U.S. Cl. CPC G01N 29/041; G01N 2291/02827; G01N 29/2412

(57) ABSTRACT

A non-contact dynamic stiffness measurement system includes a base, a test bar, an exciter, a force sensor, a laser Doppler velocimeter, and a controller. The force sensor is connected to the exciter and the base. The exciter is located between the test bar and the force sensor. The controller is electrically connected to the force sensor and the laser Doppler velocimeter. The test bar is detachably set in a holder of the main shaft under test. The exciter provides an electromagnetic force to the test bar. The force sensor measures the acting force of the exciter. The laser Doppler velocimeter provides a first laser beam and a second laser beam. The laser Doppler velocimeter measures a vibration response with reflected laser beams. The controller determines an equivalent main shaft stiffness value of the main shaft under test according to the acting force and the vibration response.

### CROSS-REFERENCE TO RELATED APPLICATIONS

This non-provisional application claims priority under 35 U.S.C. § 119(a) on Patent Application No(s). 105135179 filed in Taiwan, R.O.C. on Oct. 28, 2016, the entire contents of which are hereby incorporated by reference.

### TECHNICAL FIELD

The disclosure relates to a non-contact dynamic stiffness measurement system for machine tools, and a method thereof.

### BACKGROUND

A machine tool provides drive power to make relative movement between workpieces and cutting tools, so as to produce precise components by cutting off extra material of a metal block. Generally speaking, a main shaft of a machine tool drives a cutting tool held in the shaft to rotate to provide cutting force, and it is why a machine tool should be stiff enough to provide stable cutting force while cutting workpieces to meet expected accuracy.

Measurement of stiffness of the main shaft under static state is a well-established technique. However, the dynamic characteristics of the main shaft under a rotating state is quite different; a general static impact test for dynamic characteristic measurement would not be suitable when the main shaft is under rotation, and the characteristic of a rotating main shaft can not be predicted. Bearing deterioration is a common damage factor for all main shafts and bearing stiffness varies nonlinearly, which both become difficult to be measured directly if rotation speed changes. Misjudgment is easily made therefore.

### SUMMARY

A non-contact dynamic stiffness measurement system and a method thereof are disclosed. Under the condition that main shaft is rotating, the non-contact measurement system is used to measure the stiffness of the main shaft of machine tools.

A non-contact dynamic stiffness measurement system suitable for a main shaft is disclosed. The non-contact dynamic stiffness measurement system includes a base, a test bar, an exciter, a force sensor, a laser Doppler velocimeter and a controller. The force sensor is connected to the exciter and the base. The exciter is located between the test bar and the force sensor. The controller is electrically connected to the force sensor and the laser Doppler velocimeter. The test bar is detachably held in a tool holder of the main shaft under test. The exciter provides an electromagnetic force to the test bar. The force sensor measures the acting force of the exciter. The laser Doppler velocimeter provides a first laser beam and a second laser beam. The laser Doppler velocimeter measures vibration responses with reflected laser beams. The controller determines an equivalent main shaft stiffness value of the main shaft under test according to the acting force and the vibration response.

A method for non-contact dynamic stiffness measurement is also disclosed. The method comprises: making the main shaft to rotate, the test bar rotates with the main shaft; providing by the exciter the electromagnetic force to the rotating test bar, and sensing by the force sensor the acting force of the exciter; providing by the laser Doppler velocimeter the first laser beam and the second laser beam to the rotating test bar; generating the vibration response by the laser Doppler velocimeter according to reflected laser beams of the first laser beam and the second laser beam; and determining the equivalent main shaft stiffness value of the main shaft according to the acting force and the vibration response.

### BRIEF DESCRIPTION OF THE DRAWINGS

The present disclosure will become more fully understood from the detailed description given herein below and the accompanying drawings which are given by way of illustration only and thus are not limitative of the present disclosure and wherein:

FIG. 1A is a schematic view illustrating the relative position of each component in the non-contact dynamic stiffness measurement system of one of the embodiments of the present disclosure;

FIG. 1B is a schematic view illustrating the relative position of each component in the non-contact dynamic stiffness measurement system of another embodiment of the present disclosure;

FIG. 2A is a schematic view illustrating the relative position of each component in the non-contact dynamic stiffness measurement system of one another embodiment of the present disclosure;

FIG. 2B is a schematic view illustrating the relative position of each component in the non-contact dynamic stiffness measurement system of yet another embodiment of the present disclosure;

FIG. 3A is a schematic view illustrating the relative position of each component in the non-contact dynamic stiffness measurement system of further another embodiment of the present disclosure;

FIG. 3B is a schematic view illustrating the relative position of each component in the non-contact dynamic stiffness measurement system of further one another embodiment of the present disclosure;

FIG. 4A is a schematic view illustrating the 3D view of the non-contact dynamic stiffness measurement system of one of the embodiments of the present disclosure;

FIG. 4B is a schematic view illustrating the lateral view of the non-contact dynamic stiffness measurement system of one of the embodiments of the present disclosure;

FIG. 4C is a schematic view illustrating the structure of the first electromagnet and the second electromagnet of the non-contact dynamic stiffness measurement system of one of the embodiments of the present disclosure;

FIG. 4D is a schematic view illustrating the structure of the first electromagnet and the second electromagnet of the non-contact dynamic stiffness measurement system of one another embodiment of the present disclosure;

FIG. 4E is a schematic view illustrating the 3D view of the core of the first electromagnet of one of the embodiments of the present disclosure;

FIG. 5 is a schematic view illustrating how the non-contact dynamic stiffness measurement system of one of the embodiments of the present disclosure obtains the frequency response;

FIG. 6 is a schematic view illustrating the enduring force of the main shaft of one of the embodiments of the present disclosure;

FIG. 7 is a schematic view illustrating the model of the main shaft of one of the embodiments of the present disclosure;

FIG. 8 is a schematic view illustrating the equivalent main shaft stiffness value relative to different rotation speeds of one of the embodiments of the present disclosure;

FIG. 9A is a schematic view illustrating two vibration modes under a fixed rotation speed of one of the embodiments of the present disclosure;

FIG. 9B is a schematic view illustrating another two vibration modes under a fixed rotation speed of one of the embodiments of the present disclosure; and

FIG. 10 is a schematic view illustrating flowchart of the method for non-contact dynamic stiffness measurement of one of the embodiments of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments can be practiced without these specific details. In other instances, well-known structures and devices are schematically shown in order to simplify the drawing.

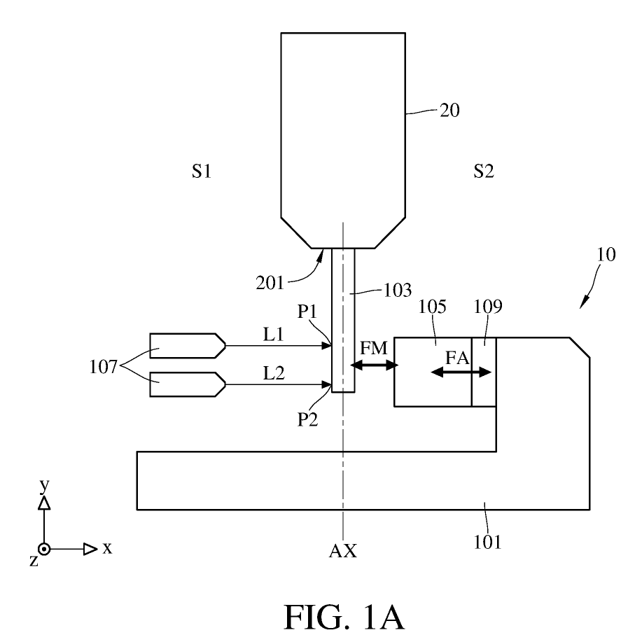

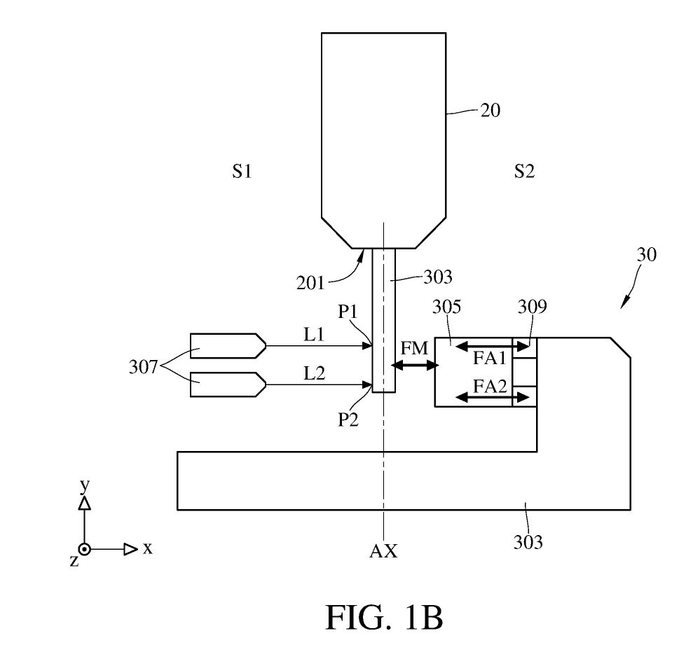

FIG. 1A is a schematic view illustrating the relative position of each component in the non-contact dynamic stiffness measurement system of one of the embodiments of the present disclosure. As shown in FIG. 1A, the non-contact dynamic stiffness measurement system 10 has a base 101, a test bar 103, an exciter 105, a force sensor 109, a laser Doppler velocimeter 107 and a controller (not shown in the Figure). The force sensor 109 connects with the exciter 105 and the base 101. The exciter 105 is located between the test bar 103 and the force sensor 109. The controller electrically connects the force sensor 109 and the laser Doppler velocimeter 107. The test bar 103 is detachably held in a holder 201 of the main shaft 20. The main shaft 20 can be the main shaft of a machine tool, or other kinds of shaft, and can be used for cutting workpieces by the cutting force provided thereof. The main shaft 20 can be a component with a core shaft and at least one bearing, but the form of the main shaft 20 is not limited to such particular form. The controller can be a computer, a processor or other kinds of circuit with computing function inside or outside the machine tool.

When the test bar 103 is held in the holder 201, the exciter 105 generates and provides an intermittent electromagnetic force FM to the test bar 103. The test bar 103 has magnetic sensitivity property since it is made of magnetic sensitive material. When the exciter 105 provides the electromagnetic force FM to the test bar 103, the rotating test bar 103 vibrates based on the direction and the magnitude of the electromagnetic force FM, therefore drives the main shaft 20 to vibrate accordingly. In one embodiment, the exciter 105 has one single excitation unit, and the electromagnetic force FM is provided by the single excitation unit. In one another embodiment, the exciter 105 has multiple excitation units, and electromagnetic forces with different directions are provided by these excitation units. In one embodiment, the direction and the magnitude of the electromagnetic force FM vary with time. Exciter 105 can be an electromagnet, and the detail descriptions of it would be discussed later.

The force sensor 109 is configured to sense an acting force FA of the exciter 105. As described previously, the force sensor 109 connects with the exciter 105, so that when the exciter 105 provides an electromagnetic force FM to the test bar 103, the exciter 105 will also takes a reaction force of the electromagnetic force FM. In one embodiment, the force sensor 109 then measure the reaction force for further processing. FIG. 1B is a schematic view illustrating the relative position of each component in the non-contact dynamic stiffness measurement system of another embodiment of the present disclosure. The relative layout of each component of the non-contact dynamic stiffness measurement system 30 is similar with the system shown in FIG. 1A, and thus detail descriptions would be omitted for precise purpose. In the embodiment as shown in FIG. 1B, the non-contact dynamic stiffness measurement system 30 has multiple force sensors 309 for sensing the acting force FA. In the embodiment as shown in FIG. 1A, the force sensor 109 can be arranged collinearly or not collinearly with the electromagnetic force FM, and in the embodiment as shown in FIG. 1B, each force sensor 309 can be arranged coplanarly with the electromagnetic force FM or not. The arrangements of the force sensor 309 can correlate with the following analysis and computation, the detail descriptions would however omitted since the arrangements can be performed with respect to actual demand by a person with ordinary skill in the art.

As shown in FIG. 1A, two laser Doppler velocimeters 107 are taken as example to respectively provide a first laser beam L1 to a first position P1 of the test bar 103, and a second laser beam L2 to a second position P2 of the test bar 103. The first laser beam L1 and the second laser beam L2 are parallel to each other, so that the first position P1 is different from the second position P2. However, the distance between the first position P1 and the second position P2 is not limited. The first laser beam L1 and the second laser beam L2 are respectively reflected by the test bar 103. The laser Doppler velocimeters 107 generate a vibration response of the first position P1 and the second position P2 according to the reflected first laser beam L1 reflected by the test bar 103, and the reflected second laser beam L2 reflected by the test bar 103. In one embodiment, the vibration response can be a corresponding displacement of the first position P1 and the second position P2 relative to a core axis AX with regard to time; or a continuous signal formed by multiple displacements measured in a certain period of time, then a frequency response generated by the continuous signal to be taken as the vibration response.

The controller determines an equivalent main shaft stiffness value of the main shaft when rotating, according to the acting force FA measured by the force sensor 109, and the vibration response measured by the laser Doppler velocimeters 107.

In one embodiment, the test bar 103 has a core axis AX, and the extension direction of the core axis AX of the test bar 103 is different from the direction of the electromagnetic force FM, the propagation direction of the first laser beam L1 and the propagation direction of the second laser beam L2. The core axis AX, the first laser beam L1, the second laser beam L2, the electromagnetic force FM and the acting force FA are all on the same plane. As the embodiment shown in FIG. 1, the core axis AX extends along with y axis, the first laser beam L1 and the second laser beam L2 propagate both along with x axis. The directions of the electromagnetic force FM and the acting force FA are parallel with x axis. From above, the propagation direction of the first laser beam L1, the propagation direction of the second laser beam L2, the direction of the electromagnetic force FM and the acting force FA are parallel with each other. In one embodiment, the electromagnetic force FM acts on the middle point of the first poison P1 and the second position P2, but the action thereof should not be limiting the scope of the present disclosure.

In the embodiments shown in FIG. 1A and FIG. 1B, the core axis AX defines a first side S1 and a second side S2. As an example, the force sensors 109, 309 locate at the second side S2, and the source of the first laser beam L1 and the source of the second laser beam L2 locate at the opposite first side S1. The emitting direction of the first laser beam L1 is the same as the emitting direction of the second laser beam L2.

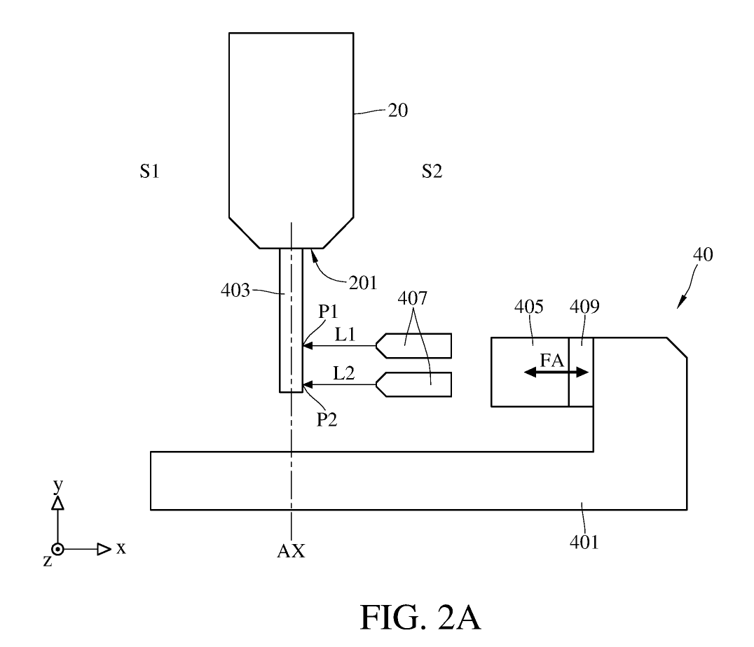

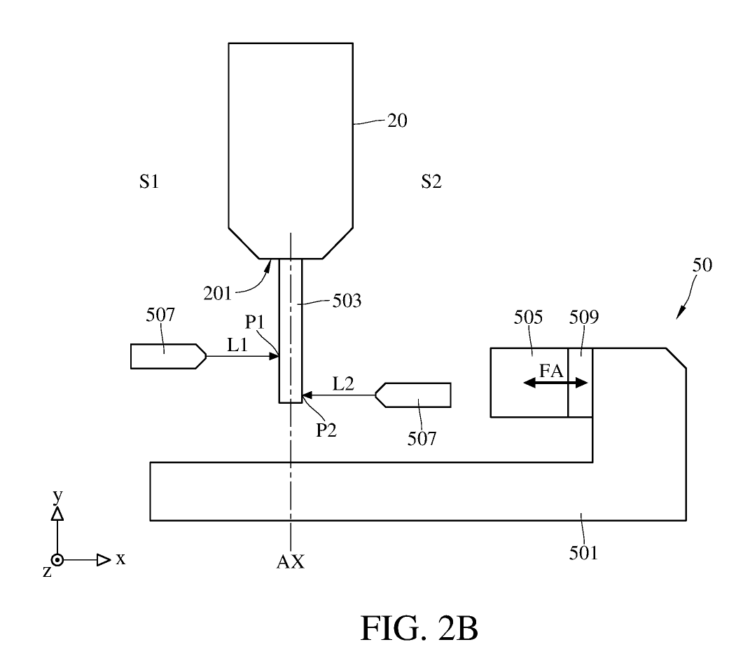

FIG. 2A is a schematic view illustrating the relative position of each component in the non-contact dynamic stiffness measurement system of one another embodiment of the present disclosure. In the embodiment shown in FIG. 2A, the core axis AX defines a first side S1 and a second side S2. The source of the first laser beam L1, the source of the second laser beam L2 and the force sensor 409 are located at the second side S2. The emitting direction of the first laser beam L1 is the same as the emitting direction of the second laser beam L2. A person with ordinary skill in the art can understand that the source of the first laser beam L1, the source of the second laser beam L2 and the force sensor 409 can as well be located at the first side S1 alternatively.

FIG. 2B is a schematic view illustrating the relative position of each component in the non-contact dynamic stiffness measurement system of yet another embodiment of the present disclosure. In the embodiment shown in FIG. 2A, the core axis AX defines a first side S1 and a second side S2. The force sensor 509 is located at the second side S2. The source of the first laser beam L1 is located at the first side S1, and the source of the second laser beam S2 is located at the second side S2. The emitting direction of the first laser beam L1 is opposite to the emitting direction of the second laser beam L2. A person with ordinary skill in the art can understand that the source of the first laser beam L1 can as well be at the second side S2, and the source of the second laser beam L2 can be at the first side S1.

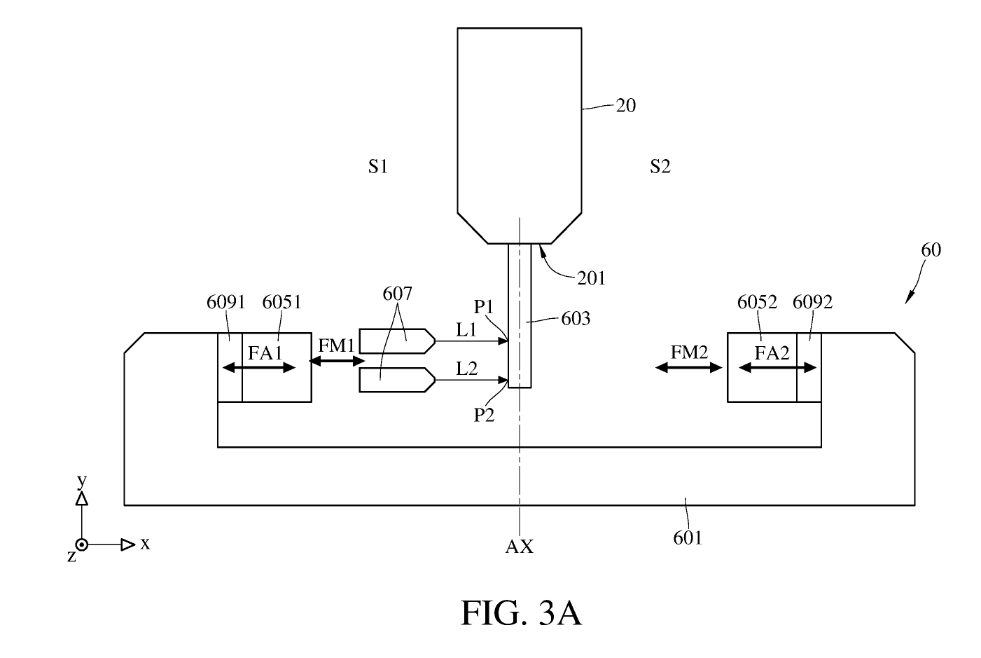

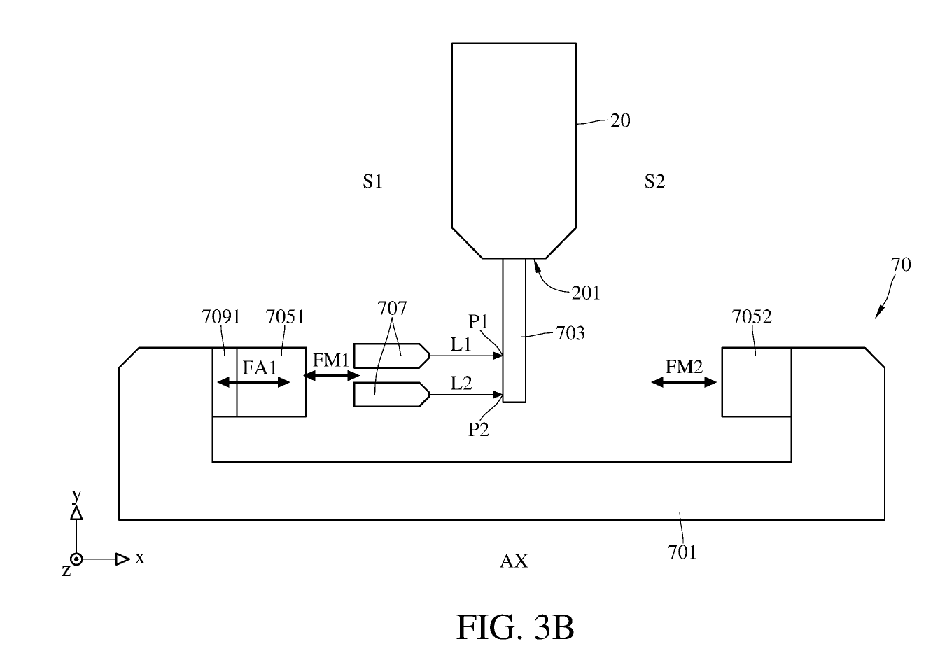

FIG. 3A is a schematic view illustrating the relative position of each component in the non-contact dynamic stiffness measurement system of further another embodiment of the present disclosure. In the embodiment shown in FIG. 3A, the exciter 605 of the non-contact dynamic stiffness measurement system 60 has a first excitation unit 6051 and a second excitation unit 6052. The first excitation unit 6051 is located at the first side S1 and the second excitation unit 6052 is located at the second side S2. The first excitation unit 6051 provides a first electromagnetic force FM1 to the test bar 603 and the second excitation unit 6052 provides a second electromagnetic force FM2 to the test bar 603. In the present embodiment, in the mean time, the direction of the electromagnetic force FM1 is the same as the direction of the second electromagnetic force FM2, and the electromagnetic force FM is the sum of the first electromagnetic force FM1 and the second electromagnetic force FM2. In the present embodiment, the non-contact dynamic stiffness measurement system 60 has a force sensor 6091 and a second force sensor 6092. The force sensor 6091 connects with the first excitation unit 6051. The force sensor 6092 connects with the second excitation unit 6052. The force sensor 6091, 6092 are respectively configured to sense the acting force FA1 of the first excitation unit 6051 and the acting force FA2 of the second excitation unit 6052. As described previously, the acting force FA1 is the reaction force of the first electromagnetic force FM1, and the acting force FA2 is the reaction force of the second electromagnetic force FM2. The controller determines the magnitude of the electromagnetic force FM based on the acting force FA1 and the acting force FA2, and then proceeds the following analysis.

With FIG. 3B referred together, where FIG. 3B is a schematic view illustrating the relative position of each component in the non-contact dynamic stiffness measurement system of further one another embodiment of the present disclosure. The layout of each component in the non-contact dynamic stiffness measurement system 70 shown in FIG. 3B is similar to that in FIG. 3A, wherein the difference is, the exciter 70 of the non-contact dynamic stiffness measurement system 70 has only one effective first excitation unit 7051. In the present embodiment, the magnitude of the first electromagnetic force FM1 given by the first excitation unit 7051 is revised to be the same as the magnitude of the second electromagnetic force FM2. In other words, the magnitude of acting force FA can be derived as long as the magnitude of acting force FA1 is known, and then the following analysis can be proceeded.

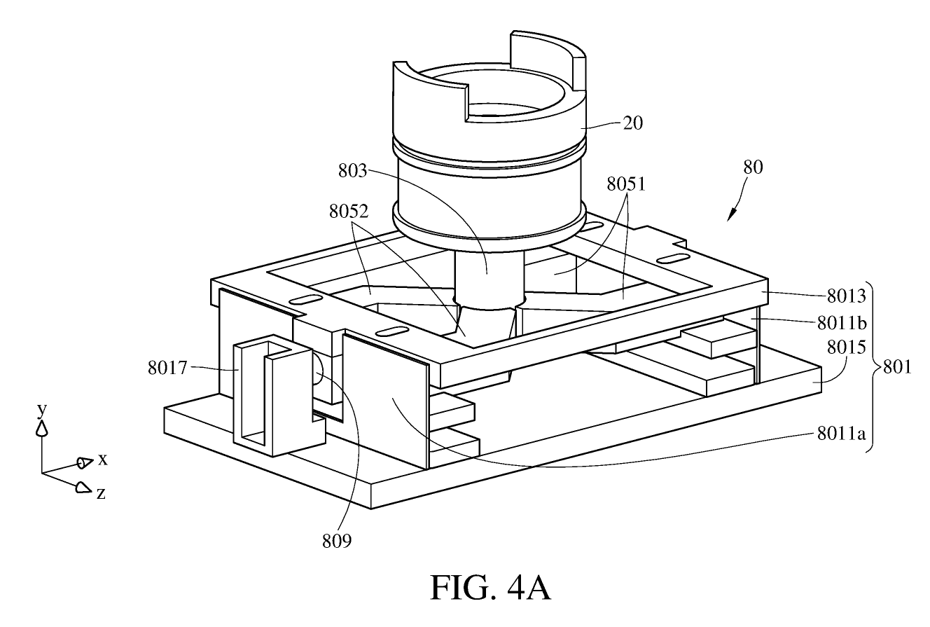

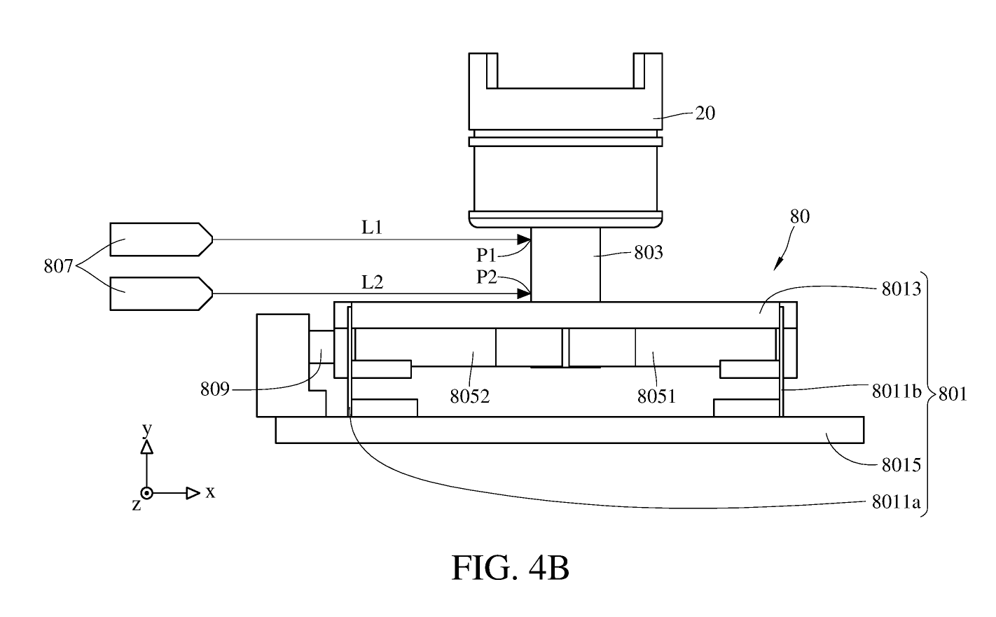

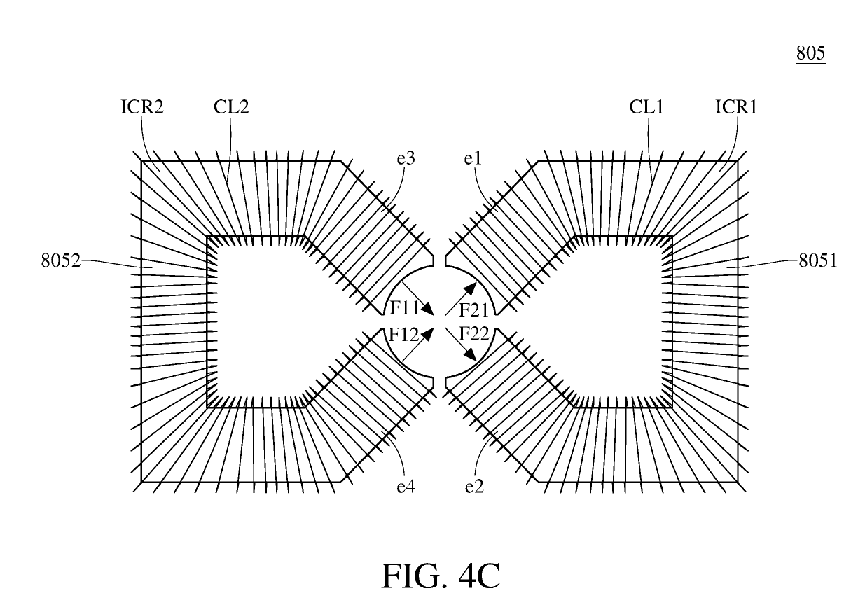

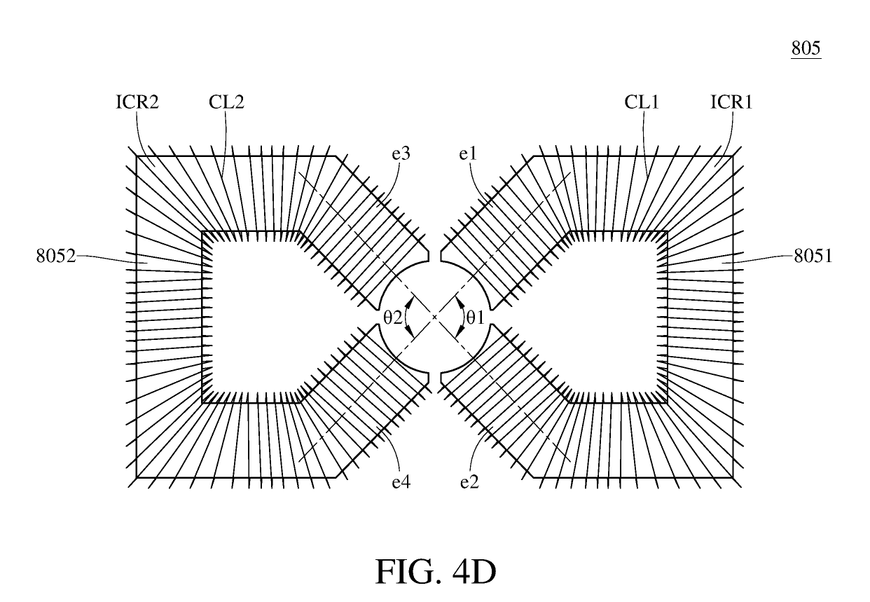

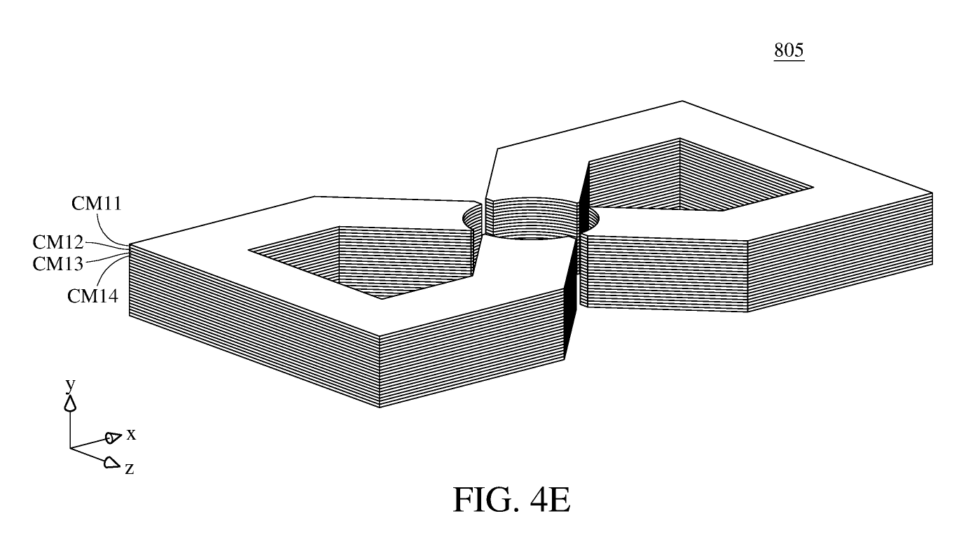

Move on to FIG. 4A, FIG. 4B and FIG. 4C for description on the specific structure of the non-contact dynamic stiffness measurement system of one embodiment. FIG. 4A is a schematic view illustrating the 3D view of the non-contact dynamic stiffness measurement system of one of the embodiments of the present disclosure, and FIG. 4B is a schematic view illustrating the lateral view of the non-contact dynamic stiffness measurement system of one of the embodiments of the present disclosure. In the embodiment shown in FIG. 4A and FIG. 4B, the relative position of each component is substantially the same as that in FIG. 1A. Wherein, the base 801 further comprises a bottom base 8015, supporting elastic pieces 8011a, 8011b, a supporting rack 8013 and a holding unit 8017. The supporting elastic pieces 8011a, 8011b are disposed on the bottom base 8015, and the supporting rack 8013 is disposed on the supporting elastic pieces 8011a, 8011b. In the present embodiment, the supporting elastic pieces 8011a and 8011b respectively have an opening (not shown in the Figure), the supporting rack 8013 buckles respectively with the supporting elastic pieces 8011a, 8011b through the openings. The holding unit 8017 is disposed on the bottom base 8015.

The supporting rack 8013 is configured to install the exciter 805, the holding unit 8017 connects the force sensor 809, and holding unit 8017 supports the force sensor 809. In the present embodiment, the exciter 805 has a first excitation unit 8051 and a second excitation unit 8052, and the first excitation unit 8051 is a first electromagnet and the second excitation unit 8052 is a second electromagnet namely. The terms of first electromagnet 8051 and second electromagnet 8052 would be used for the following descriptions.

The implementation aspect of the exciter 805 would be delineated with FIG. 4C and FIG. 4D refereed together. FIG. 4C is a schematic view illustrating the structure of the first electromagnet and the second electromagnet of the non-contact dynamic stiffness measurement system of one of the embodiments of the present disclosure. FIG. 4D is a schematic view illustrating the structure of the first electromagnet and the second electromagnet of the non-contact dynamic stiffness measurement system of one another embodiment of the present disclosure. In order to prevent misunderstanding to the Figures, test bar 803 would not be shown in FIG. 4C. The first electromagnet 8051 comprises a core ICR1 and a coil CL1. The second electromagnet 8052 comprises a core ICR2 and a coil CL2. The coil CL1 winds around the core ICR1 and the coil CL2 winds around the core ICR2. The first electromagnet 8051 has a first end e1 and a second end e2, wherein the first end e1 and the second end e2 point respectively at the test bar 903. The second electromagnet 8052 has a third end e3 and a fourth end e4, wherein the third end e3 and the fourth end e4 point respectively at the test bar 803. The first end e1, the second end e2, the third end e3 and the fourth end e4 do not contact with the test bar 803. As shown in FIG. 4D, the extension direction of the first end e1 overlaps with the extension direction of the fourth end e4, and the extension direction of the second end e2 overlaps with the extension direction of the third end e3. In the present embodiment, take the first end e1 and second end e2 as an example, the extension direction of both forms an angle θ1, wherein θ1 is 90 degree. Take the third end e3 and fourth end e4 as another example, the extension direction of both forms an angle θ2, wherein θ2 is 90 degree also. In the present embodiment, θ1 equals to θ2, however this should not be limiting the scope of the present disclosure.

For the above-mentioned structure of the exciter 805, the first electromagnet 8051 provides a component F21 through the first end e1, and the first electromagnet 8051 provides a component F22 through the second end e2. The sum of components F21 and F22 is the aforementioned electromagnetic force FM1. Similarly, the second electromagnet 8052 provides a component F11 through the third end e3, and the second electromagnet 8052 provides a component F12 through the fourth end e4. The sum of components F11 and F12 is the aforementioned second electromagnetic force FM2. In another embodiment, the coil CL1 and coil CL2 have a predetermined winding and a predetermined density, which make magnitudes of the first electromagnetic force FM1 and the second electromagnetic force FM2 to be the same. In one embodiment, the current phases of the first electromagnet 8051 and the second electromagnet 8052 are controlled to be having a 90 degree difference, which makes the directions of the first electromagnetic force FM1 and the second electromagnetic force FM2 to be the same. In the present embodiment, the direction of the electromagnetic force FM is parallel with x axis.

FIG. 4E is a schematic view illustrating the 3D view of the core of the first electromagnet of one of the embodiments of the present disclosure. As shown in FIG. 4E, the core ICR2 of the second electromagnet 8052 has multiple magnetic conducting sub-layers, which are labeled as CM11-CM14. Magnetic conducting sub-layers CM11-CM14 stack along a stacking direction. Magnetic conducting sub-layers CM11-CM14 can be, but not limit to, silicon steel sheets. In the present embodiment, the stacking direction is parallel with y axis, and the magnetic direction of the second electromagnet 8052 is on xz plane. That is to say, the stacking direction is different from the magnetic direction of the second electromagnet 8052. By this stacking structure, the magnetic field generated by the second electromagnet 8052 can be unified, or in other words the magnetic lines generated by the second electromagnet 8052 can be unified, and can increase the magnetic lines per unit area. The core ICR1 of the first electromagnet 8051 has the same structure of the core ICR2 of the second electromagnet 8052, and thus detail descriptions thereof would be omitted for convenience.

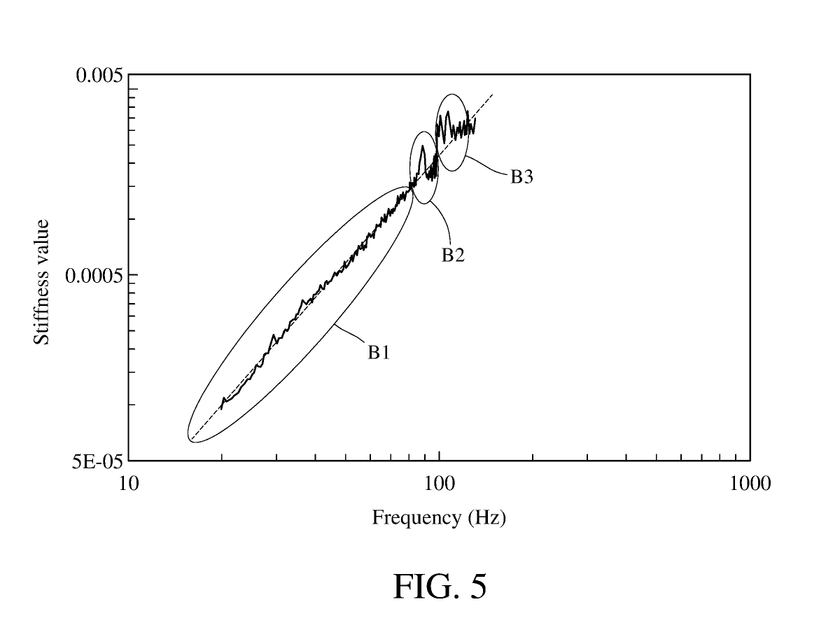

Referring back to FIG. 1A for analysis after the acting force FA and the vibration response of the first position P1 and the second position P2 are obtained. According to embodiment shown in FIG. 1A, the non-contact dynamic stiffness measurement system 10 obtains the measurement result on the acting force FA, and the vibration response of the first position P1 and the second P1 as described before. The non-contact dynamic stiffness measurement system 10 further obtains a frequency response based on the measurement result on the acting force FA, and the vibration response of the first position P1 and the second P1. FIG. 5 is a schematic view illustrating how the non-contact dynamic stiffness measurement system of one of the embodiments of the present disclosure obtains the frequency response. In FIG. 5, the horizontal axis stands for logarithm of frequency, and the unit thereof is Hertz (Hz). The vertical axis stands for logarithm of the magnitude of frequency response, and the unit thereof is mm/N. As shown in FIG. 5, a first frequency band B1 can be defined by the frequency response according to magnitude of the frequency, and a second frequency band B2 and a third frequency band B3 also can be defined according to a curve shape. In one embodiment, the second frequency band B2 is a peak value from low frequency to high frequency of the curve shape. The third frequency band B2 is a second peak value from low frequency to high frequency of the curve shape. The definition of the peak value can be defined by people with ordinary skill in the art by different demands, and thus the definition disclosed should not be limiting the scope of the present disclosure.

The first frequency band B1 can be seen as a relatively low frequency band, and the line shape of the frequency response in the first frequency band B1 approximates to a straight line. The inverse of the slope of the straight line is the equivalent core shaft stiffness value of the main shaft 20. The inverse of a first peak value of the second frequency band B2 corresponds the front shaft equivalent stiffness value of the front shaft of the main shaft 20, and the inverse of a second peak value of the third frequency band B3 corresponds the back shaft equivalent stiffness value of the back shaft of the main shaft 20. In other words, the dynamic measurement system 10 obtains the equivalent core shaft stiffness of the main shaft 20 based on the slope of the equivalent straight line of the second frequency band B1, obtains the front shaft equivalent stiffness value based on the equivalent stiffness value and frequency correspond to the first peak value of the second frequency band B2, and obtains the back shaft equivalent stiffness value based on the equivalent stiffness value and frequency correspond to the second peak value of the third frequency band B3. Moreover, the non-contact dynamic stiffness measurement system 10 obtains the equivalent stiffness value of the main shaft according to the front shaft equivalent stiffness value, the back shaft equivalent stiffness value and the equivalent core shaft stiffness value.

In other words, making the main shaft 20 to rotate with different speeds, under this condition, acting force FA and vibration response with different rotating speeds can be obtained by using the above-mentioned steps, therefore making the non-contact dynamic stiffness measurement system 10 to obtain different frequency response function. And, with the front shaft equivalent stiffness value, the back shaft equivalent stiffness value and the equivalent core shaft stiffness value under different frequency band of the frequency response function, the non-contact dynamic stiffness measurement system 10 can obtain the main shaft equivalent stiffness value under different rotating speed. Take FIG. 5 as an example, the frequency response function is taken under 6000 revolution/minute (RPM).

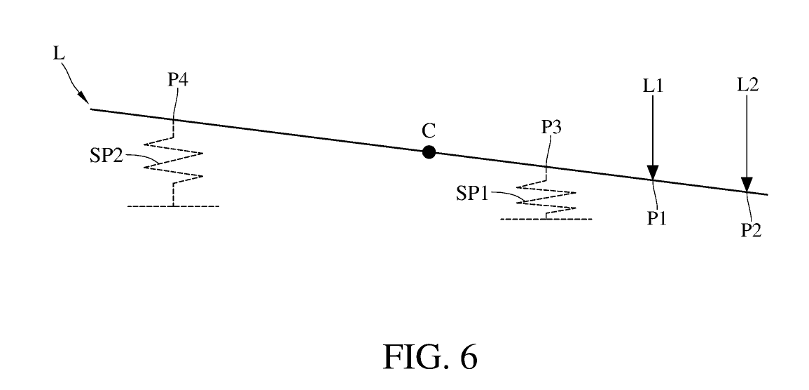

FIG. 6 is a schematic view illustrating the enduring force of the main shaft of one of the embodiments of the present disclosure. The equivalent axis line L formed by the main shaft 20 and test bar 103, and the force endurance of the equivalent axis line L are depicted in FIG. 6. A first position P1, a second position P2, a third position P3 and a fourth position P4 are labeled on the equivalent axis line L. As described previously, the first position P1 and the second position P2 correspond to the first laser beam L1 and the second laser beam L2, the third position P3 corresponds to the position of the front shaft of the main shaft 20, and the fourth position P4 corresponds to the position of the back shaft of the main shaft 20. By static equilibrium of the equivalent axis line L, the controller can obtain the front shaft equivalent stiffness value and the back shaft equivalent stiffness value. Under static equilibrium condition, the third position P3 and the fourth position P4 are tantamount to endure the acting force provided by virtual springs SP1 and SP2, and thus reach a balance state with the aforementioned electromagnetic force FM. The elastic coefficients of the virtual springs SP1 and SP2 are respectively tantamount to the equivalent stiffness value of the front shaft and the back shaft. The static equilibrium of the equivalent axis line L can be expressed as follow:

$$[ \begin{matrix}{k}_{b 1} & 0 \\ 0 & {k}_{b 2}\end{matrix} ] \{ \begin{matrix}{x}_{1} \\ {x}_{2}\end{matrix} \} = \{ F \} ,$$

wherein x₁ is front shaft displacement, x₂ is the back shaft displacement, k_{b1} is the equivalent stiffness of front shaft, k_{b2} is the equivalent stiffness of back shaft, and F is the electromagnetic excitation force or the acting force provided by springs SP1 and SP2.

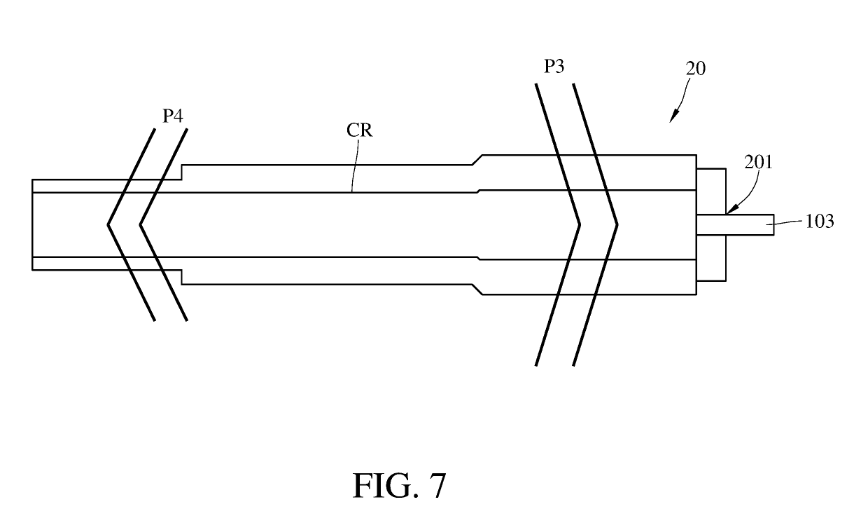

FIG. 7 is a schematic view illustrating the model of the main shaft of one of the embodiments of the present disclosure. According to the above-mentioned front shaft equivalent stiffness value, the back shaft equivalent stiffness value, the relevant parameters (core shaft geometric parameters, material parameters, for example) of the core axis CR of the main shaft 20, the position of the front shaft and the position of the back shaft, the controller can establish an equivalent main shaft model. The controller can further calculate the natural frequency and vibration mode of the main shaft 20 via the equivalent main shaft model. To be more specific, the controller can build a system dynamic equation as follow:

[Mₑ]{\ddot{x}}+[Kₑ]{x}={F},

wherein [Mₑ] is the mass matrix, [Kₑ] is the equivalent stiffness matrix. Each element in the matrix can be defined freely by person with ordinary skill in the art, and the definition herein is not limited. The cross of the eigenvector and the curve equation [Φᵢ]×{Sᵢ} is the vibration mode, wherein the curve equation {Si} can be derived from multiple beam theories, however the selection for which beam theory is not limited.

The controller can further run an error matching according to the computed first mode natural frequency value, the second mode natural frequency value and the measured natural frequency value. The controller then adjusts the equivalent stiffness value based on the error matching until an error equation is stable. The error equation can be expresses as follow:

minJ(θ)=ε_{Z}^{T}W_{ε}ε_{z}+λ²Δθᵢ^{T}W_{θ}Δθᵢ,

wherein W_{ε} and W_{θ} are weight array, each element therein is a weight value, and no limitation is imposed on content of the weight array. ε_{z} is an error value, the error value can be any parameter error of the system dynamic equation, including system mass, system stiffness and shaft stiffness. Δθᵢ is a compensation value, the compensation value corresponds to error value, if the error value is the system stiffness, then the compensation value is the system stiffness. Eigenvalue is the natural frequency of the main shaft 20. When the error equation is at its minimum value, the equivalent shaft stiffness is at this moment the correct equivalent shaft stiffness, and the equivalent main shaft model can be re-built.

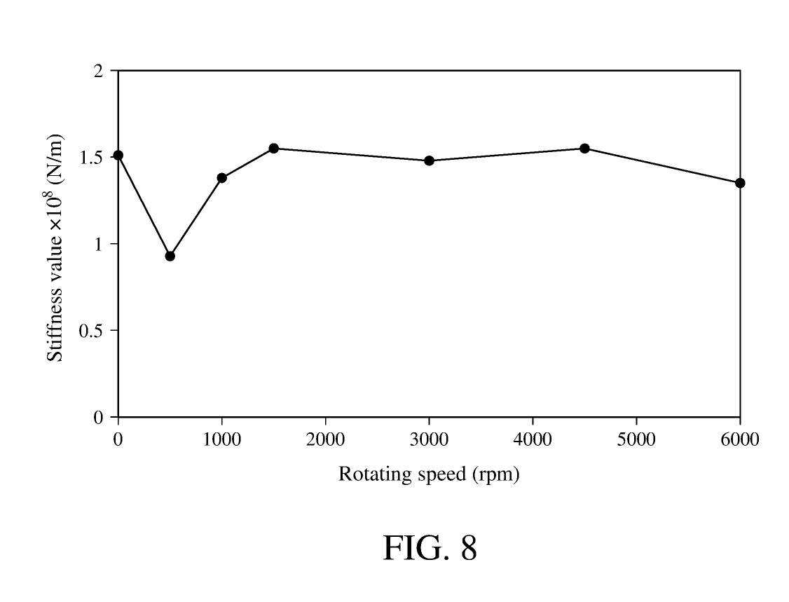

FIG. 8 is a schematic view illustrating the equivalent main shaft stiffness value relative to different rotation speeds of one of the embodiments of the present disclosure. The horizontal axis in FIG. 8 stands for rotating speed, and the unit is rpm. The vertical axis in FIG. 8 stands for adjusted stiffness value, and the unit is N/m. As described previously, by making the main shaft 20 to rotate under different speed, and performing the above-mentioned measurement steps correspondingly, the stiffness of the main shaft 20 under different speed can be measured. As seen in the experiment shown in FIG. 8, the main shaft 20 has relatively small stiffness value when rotates at nearly 500 rpm, that is, machining error could have happened when the main shaft 20 is rotating at nearly 500 rpm and thus should be prevented.

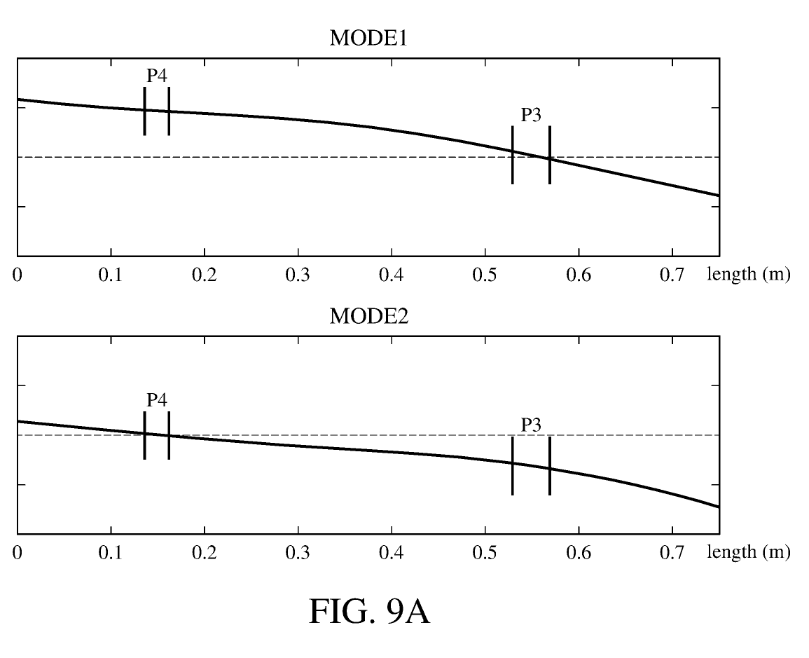

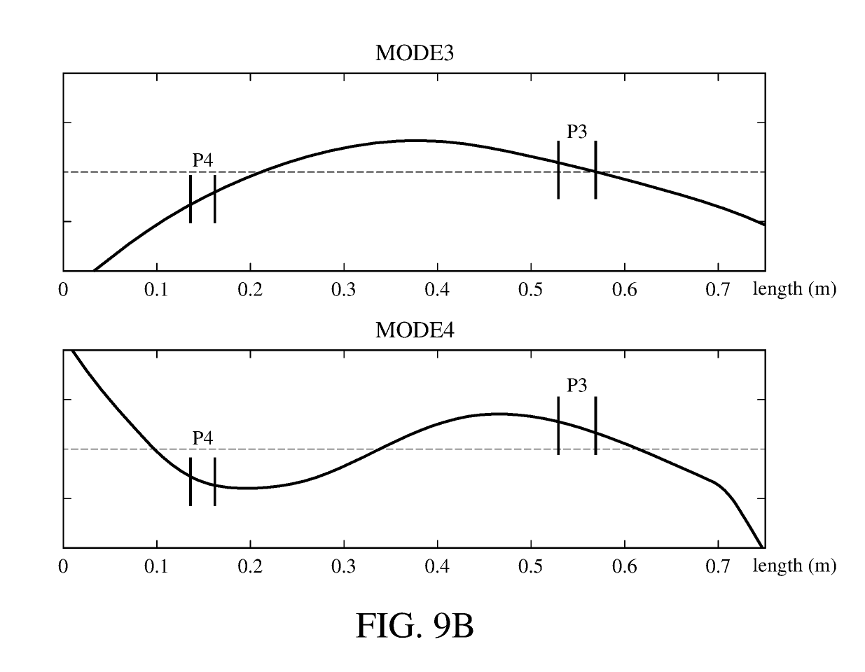

FIG. 9A is a schematic view illustrating two vibration modes under a fixed rotation speed of one of the embodiments of the present disclosure, and FIG. 9B is a schematic view illustrating another two vibration modes under a fixed rotation speed of one of the embodiments of the present disclosure. Multiple vibration modes of the main shaft 20 when rotating at 3000 rpm are shown in FIG. 9A and FIG. 9B, the vibration modes are labeled as MODE1-MODE4. To be more specific, vibration modes MODE1-MODE4 respectively correspond to the first mode natural frequency value to the fourth mode natural frequency value, and the relative magnitudes of the first mode natural frequency value to the fourth mode natural frequency value are increasing. That is to say, the first mode natural frequency value is the minimum natural frequency value among the four values, and the fourth mode natural frequency value is the maximum natural frequency value among the four values. The portions corresponding to the third position P3 and the fourth position P4 are also labeled in vibration modes MODE1-MODE4, which are the portions of the front shaft and the back shaft corresponding to the vibration modes MODE1-MODE4.

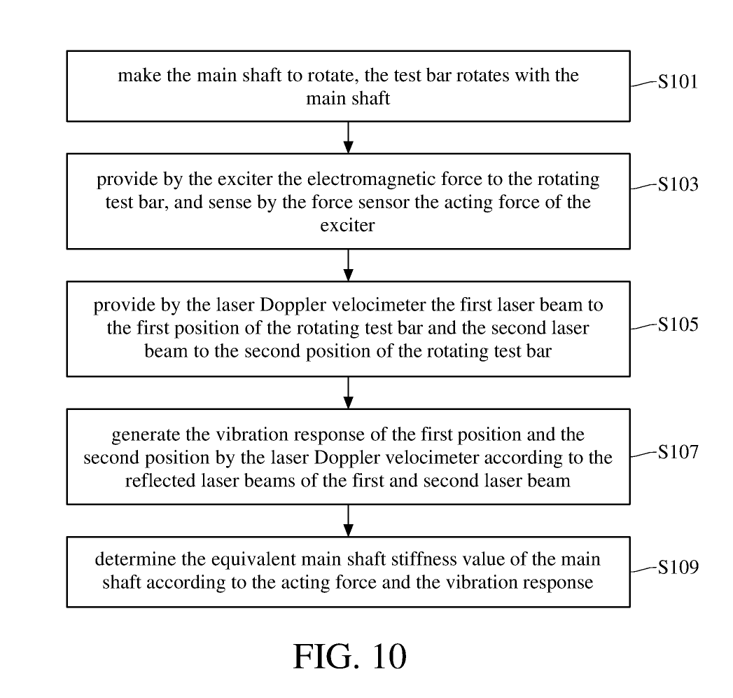

Followed by the previous descriptions, a non-contact dynamic stiffness measurement method is provided by the present disclosure, and the non-contact dynamic stiffness measurement method can be adapted to any non-contact dynamic stiffness measurement system mentioned above. FIG. 10 is a schematic view illustrating a flowchart of the method for non-contact dynamic stiffness measurement of one of the embodiments of the present disclosure. In the non-contact dynamic stiffness measurement method, in step S101, make the main shaft to rotate, the test bar rotates with the main shaft, and the rotation speed would change for calculating the stiffness value. In step S103, provide by the exciter the electromagnetic force to the rotating test bar, and sense by the force sensor the acting force of the exciter. In step S105, provide by the laser Doppler velocimeter the first laser beam to a first position of the rotating test bar and the second laser beam to a second position of the rotating test bar respectively. In step S107, generate the vibration response of the first position and the second position by the laser Doppler velocimeter according to the reflected laser beams of the first laser beam and the second laser beam. And in step S109, determine the equivalent main shaft stiffness value of the main shaft according to the acting force and the vibration response.

What is claimed is:

1. A non-contact dynamic stiffness measurement system suitable for a main shaft, comprising:
a base;
a test bar of magnetic sensitivity, configured to be detachably held in a holder of the main shaft;
at least one exciter, configured to provide a electromagnetic force;
at least one force sensor connected to the exciter and disposed on the base, configured to measure an acting force of the exciter;
at least one laser Doppler velocimeter, configured to provide a first laser beam and a second laser beam, and to generate a vibration response with reflected laser beams of the first laser beam and second laser beam; and
a controller electrically connected to the force sensor and the laser Doppler velocimeter, configured to determine an equivalent main shaft stiffness value of the main shaft according to the acting force and the vibration response.

2. The non-contact dynamic stiffness measurement system as claimed in claim 1, wherein propagation directions of the first laser beam and the second laser beam are parallel to each other.

3. The non-contact dynamic stiffness measurement system as claimed in claim 1, wherein the exciter is located between the test bar and the force sensor.

4. The non-contact dynamic stiffness measurement system as claimed in claim 1, wherein the laser Doppler velocimeter is located between the test bar and the exciter.

5. The non-contact dynamic stiffness measurement system as claimed in claim 1, wherein the test bar is located between the laser Doppler velocimeter and the exciter.

6. The non-contact dynamic stiffness measurement system as claimed in claim 1, wherein the exciter has a first excitation unit and a second excitation unit, and the first excitation unit is a first electromagnet and the second excitation unit is a second electromagnet.

7. The non-contact dynamic stiffness measurement system as claimed in claim 6, wherein the first electromagnet and the second electromagnet respectively comprises:
a core having multiple magnetic conducting sub-layers stacking along a stacking direction; and
a coil winding around the core.

8. A method for non-contact dynamic stiffness measurement, suitable for the non-contact dynamic stiffness measurement system as claimed in claim 1, comprising the steps of:
making the main shaft to rotate, the test bar rotates with the main shaft;
providing by the exciter the electromagnetic force to the rotating test bar, and sensing by the force sensor the acting force of the exciter;
providing by the laser Doppler velocimeter the first laser beam and the second laser beam respectively to the rotating test bar;
generating the vibration response by the laser Doppler velocimeter according to reflected laser beams of the first laser beam and the second laser beam; and
determining the equivalent main shaft stiffness value of the main shaft according to the acting force and the vibration response.

9. The method for non-contact dynamic stiffness measurement as claimed in claim 8, wherein the step of determining the equivalent main shaft stiffness value of the main shaft according to the acting force and the vibration response further comprises:
obtaining a frequency response function according to the acting force and the vibration response;
obtaining an equivalent core shaft stiffness value of the main shaft according to a low frequency band of the frequency response function;
obtaining an equivalent bearing stiffness value of the main shaft according to a high frequency band of the frequency response function; and
obtaining the equivalent main shaft stiffness value according to the equivalent core shaft stiffness value and the equivalent bearing stiffness value.

10. The method for non-contact dynamic stiffness measurement as claimed in claim 9, wherein the equivalent core shaft stiffness value is an inverse of a slope of the low frequency band, and the equivalent bearing stiffness value is an inverse of a peak of the high frequency band.
